(19) United States
(12) Patent Application Publication
(10) Pub. No.: US 2025/0030770 A1
(43) Pub. Date: Jan. 23, 2025

(54) SOFTWARE UPDATE SEQUENCE USING LINK LAYER DISCOVERY PROTOCOL (LLDP)

(71) Applicant: HIRSCHMANN AUTOMATION AND CONTROL GMBH, Neckartenzlingen (DE)

(72) Inventors: Zbigniew PELZER, Lenningen (DE); Stephan KEHRER, Dußlingen (DE)

(73) Assignee: HIRSCHMANN AUTOMATION AND CONTROL GMBH, Neckartenzlingen (DE)

(21) Appl. No.: 18/707,268

(22) PCT Filed: Dec. 13, 2022
(86) PCT No.: PCT/EP2022/085659

§ 371 Date: May 3, 2024

(30) Foreign Application Priority Data
Dec. 22, 2021 (DE) 10 2021 134 250.3

(51) Int. Cl. H04L 67/00; H04L 41/0213

(52) U.S. Cl. CPC H04L 67/34; H04L 41/0213

(57) ABSTRACT

A method is proposed for determining the best sequence of software updates and/or boot commands to switches, said sequence being used to allow the prevention of collisions when distributing the software updates and/or the boot commands and to allow the software update process and/or the boot command process to be optimized over time. For this purpose, a network is used in which an update station, multiple network participants, and multiple switches can communicate with one another. It is proposed to collect information relating to the switches in the network using LLDP, and the removal of the switches from the update station is determined using the collected Information. The sequence of updates and/or boot commands to the switches can then be ascertained by means of the removal process.

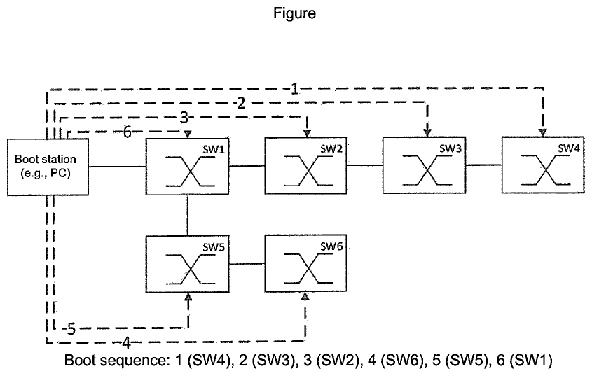

### DESCRIPTION

The present invention relates to a method for determining the sequence of updates of software, firmware, programmable logic and/or boot commands on network devices, in particular switches.

Switches are network devices that connect other network devices, also known as network participants, with each other. A fixed or programmable logic within the switches ensures the addressing of the data packets that are exchanged between the network participants.

This programmable logic and/or software should be provided with updates for safety reasons and/or for functional enhancements. In this regard, it can happen that a software update of a switch in a network fails because the order of the update (or the subsequent boot process) is not correct. This occurs in particular when many devices in the network are supplied with an update at the same time. This can lead to a switch being booted up that interrupts the boot command chain before the switches behind it receive the same command.

Typically, boot delays are used here to resolve the problem. However, this is not always sufficient to prevent problems during the update process.

The object of the present invention is therefore to resolve the aforementioned problems and to provide a secure method for updating network devices, in particular switches.

This object is achieved by the features of the claim.

To accomplish this, the order of the network devices, in particular the switches, is determined with LLDP. The boot commands are then sent in the correct order. As a result, the network devices, especially the switches, are rebooted e.g., in the line in the order of their distance from the station (e.g., a dedicated network device or a network management station) that distributes the updates. For example, the furthest away is rebooted first, then the second furthest away next, and so on.

LLDP is a layer 2 protocol which is standardized according to IEEE 802.1AB. This protocol allows information to be exchanged between neighboring network participants and network components. The protocol works independently of other protocols. It sends information about itself and receives information sent by other participants. LLDP therefore does not require communication with other devices.

For the sake of simplicity, the method is described below using switches, but is not limited to this type of network devices.

Preferably, it is proposed to first supply the most distant switch with the new software and/or the reboot command, then the second most distant, and so on. Adhering to this sequence suggested herein guarantees that the next particular software update (or boot command) will in fact reach its destination (this means that the switch to be supplied with a software update or to be booted is not located behind a switch that is currently booting and therefore cannot be reached).

The method according to the invention is shown as an example in the figure.

1.-15. (canceled)

16. A method for determining the sequence of software updates and/or boot commands to network devices, preferably switches, wherein an update station, multiple network participants and at least one switch, preferably multiple switches, can communicate with each other in a network, and wherein:
LLDP is used to collect information about the network devices, preferably the switches, in the network;
the distance of at least one switch, preferably the multiple switches, from the update station is determined by the information; and
the sequence of updates and/or boot commands to the network participants, preferably the multiple switches, is determined by the distance.

17. The method according to claim 16, wherein first those switches which are farthest away from the update station are supplied with updates and/or boot commands.

18. The method according to claim 16, wherein the sequence of updates and/or boot commands is determined from the switch with the greatest distance to the switch with the least distance to the update station.

19. The method according to claim 16, wherein management information bases (MIBs) of the switches are accessed, and the distance to the individual switches is determined via these accesses.

20. The method according to claim 19, wherein access to the MIBs is performed via the update station.

21. The method according to claim 19, wherein the access to the MIBs is performed via one of the network participants.

22. The method according to claim 16, wherein the switches are LLDP-capable.

23. The method according to claim 16, wherein network participants adjacent to the switches are LLDP-capable.

24. The method according to claim 19, wherein the access to the MIBs is performed via SNMP commands.

25. The method according to claim 16, wherein updates are initially distributed to all switches simultaneously, and only the update sequence is determined by the distance.

26. The method according to claim 16, wherein similar to the switches, routers can also benefit from the proposed method for distributing the software updates and/or boot commands.

27. The method according to claim 16, wherein the update station is designed as an independent network participant.

28. The method according to claim 16, wherein the update station is integrated in one of the switches.

29. The method according to claim 16, wherein a boot station that initiates the software updates of the other switches (or sends the boot commands) can be any device in the network such as a PC, a switch or a router.

30. The method according to claim 16, wherein the boot station is the device that distributes the software updates or sends boot commands, and wherein this function of the boot station can also be taken over by another device (switch, router or the like) in the network if required.
